(19) United States
(12) Patent Application Publication
(10) Pub. No.: US 2017/0329622 A1
(43) Pub. Date: Nov. 16, 2017

(54) SHARED VIRTUAL DATA STRUCTURE OF NESTED HYPERVISORS

(71) Applicant: Microsoft Technology Licensing, LLC, Redmond, WA (US)

(72) Inventors: Bruce J. Sherwin, JR., Woodinville, WA (US); Aditya Bhandari, Redmond, WA (US)

(21) Appl. No.: 15/152,429

(22) Filed: May 11, 2016

(51) Int. Cl. G06F 9/455

(52) U.S. Cl. CPC G06F 9/45558; G06F 2009/45583; G06F 2009/45595

(57) ABSTRACT

Using a shared virtual data structure to efficiently communicate between hypervisors within a nested virtualization environment. Execution of a child hypervisor is performed that includes notifying the child hypervisor of the existence of, and how to use, the shared virtual data structure. Execution of the child hypervisor also includes performing operations at the child hypervisor, wherein at least one of the operations includes a privileged operation. The at least one privileged operation is then intercepted while control remains with the child hypervisor. In response to intercepting the at least one privileged operation, control is then transferred to the parent hypervisor. Once control has been transferred to the parent hypervisor, the parent hypervisor executes. Execution of the parent hypervisor includes both validating at least one of the operations and causing the at least one privileged operation to occur via use of content of the shared virtual data structure.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

For example, virtual machines are often used today in order to give end users greater flexibility in the types of operating systems, resources, and applications that can be utilized. In fact, virtualization has been taken a step further, by utilizing virtual machines that execute within a hypervisor, that hypervisor itself also operating as a virtual machine that is nested within yet another hypervisor.

Such a configuration has a number of advantages. For instance, within such a configuration, a developer may be able to put his/her entire development environment within the virtual machine of the nested hypervisor. This allows the developer to deploy and test his/her software in a virtual machine, as if the developer had a physical computer system dedicated to development of that particular software.

The subject matter claimed herein is not limited to embodiments that solve any disadvantages or that operate only in environments such as those described above.

Rather, this background is only provided to illustrate one exemplary technology area where some embodiments described herein may be practiced.

### BRIEF SUMMARY

At least some embodiments described herein relate to using a shared virtual data structure to efficiently communicate between hypervisors within a nested virtualization environment. For example, embodiments may include executing a child hypervisor, wherein execution of the child hypervisor includes notifying the child hypervisor of the shared virtual data structure, and how to use the shared virtual data structure. Execution of the child hypervisor also includes performing one or more operations at the child hypervisor, wherein at least one of the one or more operations includes a privileged operation.

The at least one privileged operation is then intercepted while control remains with the child hypervisor. In response to intercepting the at least one privileged operation, control is then transferred to the parent hypervisor. Once control has been transferred to the parent hypervisor, the parent hypervisor executes. Execution of the parent hypervisor includes both validating at least one of the one or more operations and causing the at least one privileged operation to occur via use of content of the shared virtual data structure.

Using a shared virtual data structure may greatly reduce inefficiencies within nested virtualization environments that include the use of an opaque data structure to be used by nested entities. Furthermore, the control flow and program logic of a nested virtualization environment within a given architecture may be minimally changed at least partially by using a shared virtual data structure having generally the same format and semantics of the physical data structure/opaque data structure of the architecture. This advantage is obtained while still greatly reducing the complexity and inefficiencies that result from almost constant virtual exits from a child hypervisor/virtual machine accessing an opaque data structure to a parent hypervisor.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may be employed;

FIG. 2 illustrates a virtualized environment in which the principles described herein may be employed;

FIG. 3 illustrates a more specific virtualized environment in which the principles described herein may be employed;

FIG. 4 illustrates a nested virtualization environment in which the principles described herein may be employed; and

FIG. 5 illustrates a flow chart of an example method for efficient communication within a nested virtualization environment via a shared virtual data structure.

### DETAILED DESCRIPTION

At least some embodiments described herein relate to using a shared virtual data structure to efficiently communicate between hypervisors within a nested virtualization environment. For example, embodiments may include executing a child hypervisor, wherein execution of the child hypervisor includes notifying the child hypervisor of the shared virtual data structure, and how to use the shared virtual data structure. Execution of the child hypervisor also includes performing one or more operations at the child hypervisor, wherein at least one of the one or more operations includes a privileged operation.

The at least one privileged operation is then intercepted while control remains with the child hypervisor. In response to intercepting the at least one privileged operation, control is then transferred to the parent hypervisor. Once control has been transferred to the parent hypervisor, the parent hypervisor executes. Execution of the parent hypervisor includes both validating at least one of the one or more operations and causing the at least one privileged operation to occur via use of content of the shared virtual data structure.

Using a shared virtual data structure may greatly reduce inefficiencies within nested virtualization environments that include the use of an opaque data structure to be used by nested entities. Furthermore, the control flow and program logic of a nested virtualization environment within a given architecture may be minimally changed at least partially by using a shared virtual data structure having generally the same format and semantics of the physical data structure/opaque data structure of the architecture. This advantage is obtained while still greatly reducing the complexity and inefficiencies that result from almost constant virtual exits from a child hypervisor/virtual machine accessing an opaque data structure to a parent hypervisor.

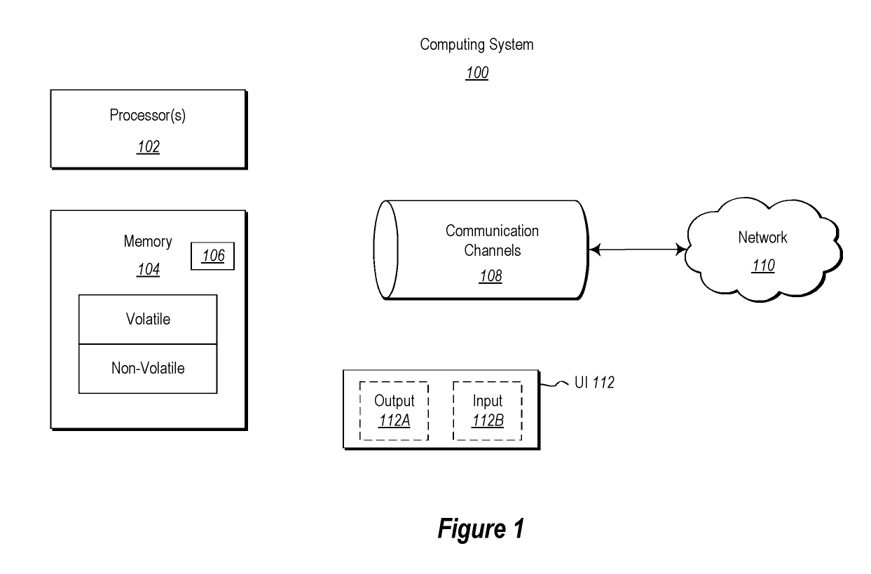

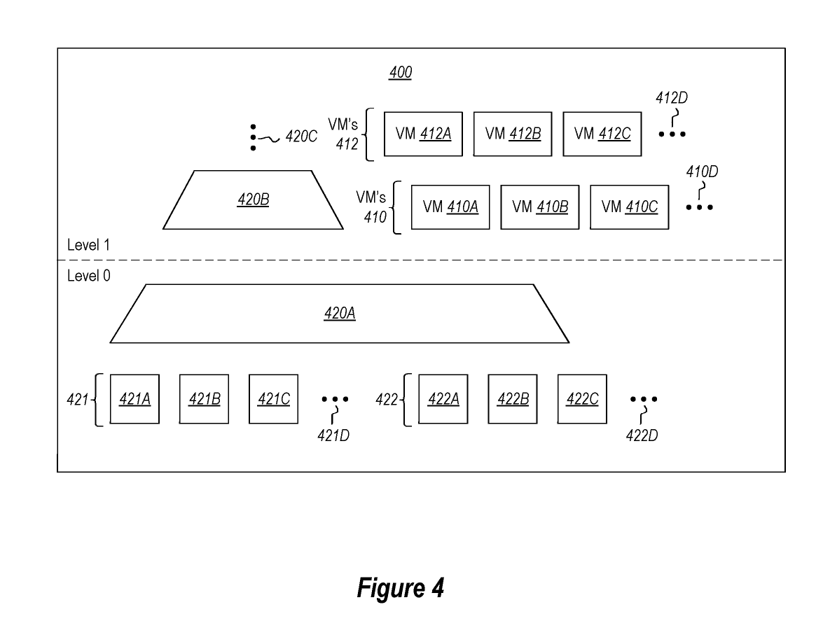

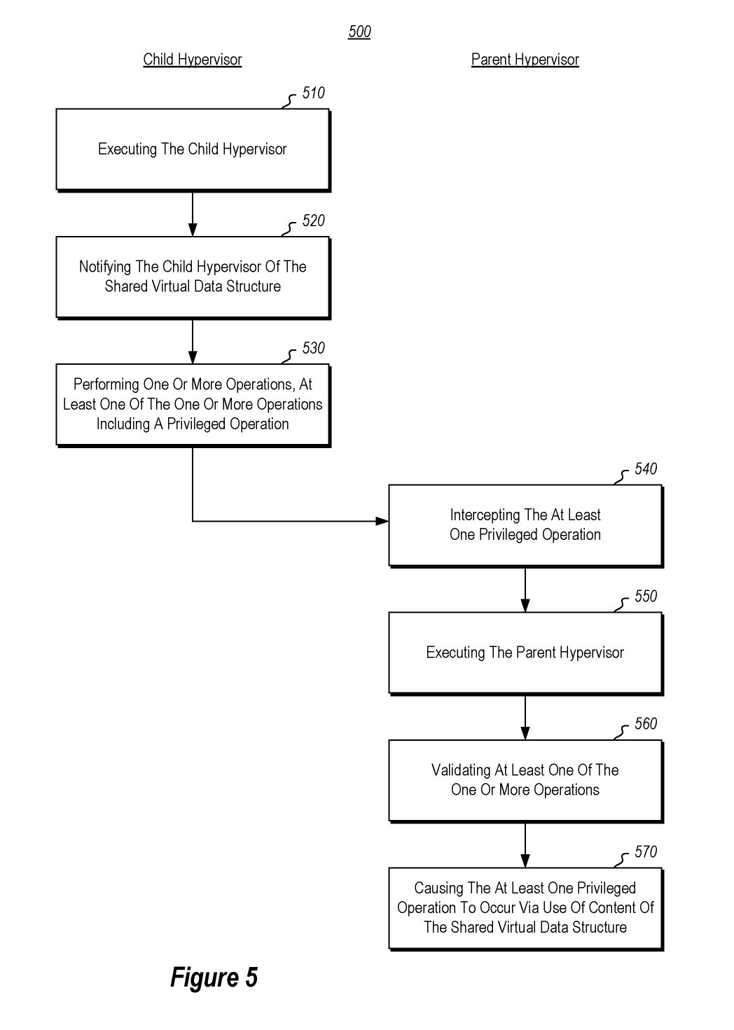

Because the principles described herein operate in the context of a computing system, and further a virtualized computing system environment, a computing system and virtualized computing system environment will first be described with respect to FIGS. 1 through 3 as enabling technologies for the principles described herein. Thereafter, further details regarding using a shared virtual data structure to efficiently communicate between hypervisors within a nested virtualization environment will be described with respect to FIGS. 4 and 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

The computing system 100 has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “controller”, “validator”, “runner”, “deployer”, “virtual machine”, “hypervisor” or the like, may also be used. As used in this description and in the case, these terms (regardless of whether the term is modified with one or more modifiers) are also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth. In accordance with the principles describe herein, alerts (whether visual, audible and/or tactile) may be presented via the output mechanism 112A.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

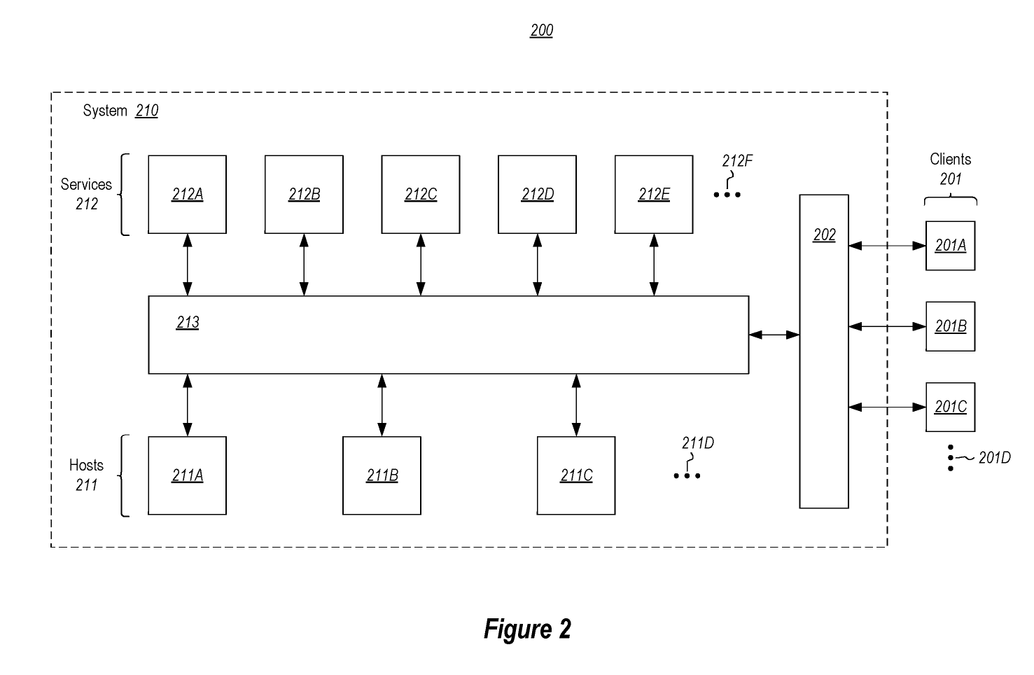

FIG. 2 symbolically illustrates an environment 200 in which the principles described herein may be employed. The environment 200 includes multiple clients 201 interacting with a system 210 using an interface 202. The environment 200 is illustrated as having three clients 201A, 201B and 201C, although the ellipses 201D represent that the principles described herein are not limited to the number of clients interfacing with the system 210 through the interface 202. The system 210 may provide services to the clients 201 on-demand and thus the number of clients 201 receiving services from the system 210 may vary over time.

Each client 201 may, for example, be structured as described above for the computing system 100 of FIG. 1. Alternatively or in addition, the client may be an application or other software module that interfaces with the system 210 through the interface 202. The interface 202 may be an application program interface that is defined in such a way that any computing system or software entity that is capable of using the application program interface may communicate with the system 210.

The system 210 may be a distributed system, although not required. In one embodiment, the system 210 is a cloud computing environment. Cloud computing environments may be distributed, although not required, and may even be distributed internationally and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The system 210 includes multiple hosts 211, that are each capable of running applications (including, for instance, hypervisors and virtual machines to support virtualization). Although the system 200 might include any number of hosts 211, there are three hosts 211A, 211B and 211C illustrated in FIG. 2, with the ellipses 211D representing that the principles described herein are not limited to the exact number of hosts that are within the system 210. There may be as few as one, with no upper limit. Furthermore, the number of hosts may be static, or might dynamically change over time as new hosts are added to the system 210, or as hosts are dropped from the system 210. Each of the hosts 211 may be structured as described above for the computing system 100 of FIG. 1.

The system 200 also includes services 212. In the illustrated example, the services 200 include five distinct services 212A, 212B, 212C, 212D and 212E, although the ellipses 212F represent that the principles described herein are not limited to the number of service in the system 210. A service coordination system 213 communicates with the hosts 211 and with the services 212 to thereby provide services requested by the clients 201, and other services (such as authentication, billing, and so forth) that may be prerequisites for the requested service.

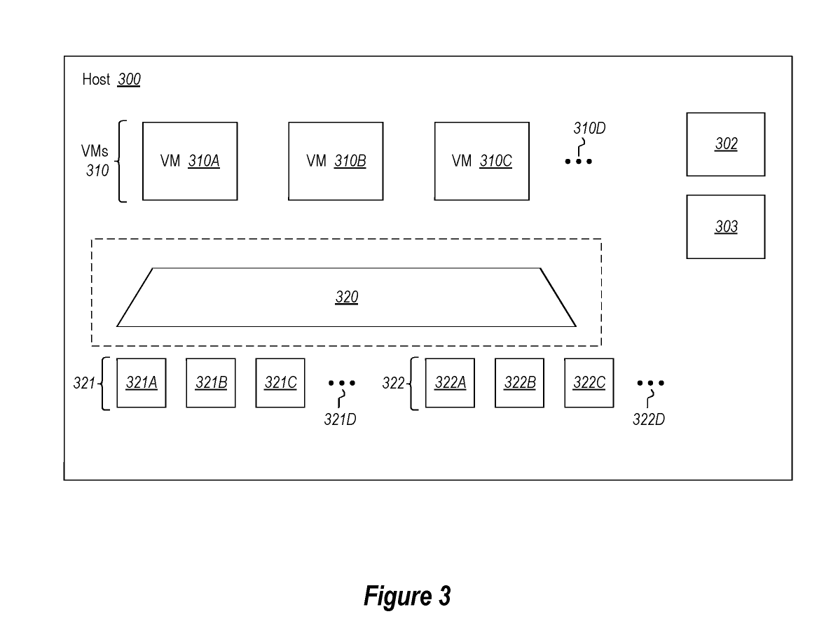

Each host is capable of running one or more, and potentially many, virtual machines. For instance, FIG. 3 abstractly illustrates a host 300 in further detail. As an example, the host 300 might represent any of the hosts 211 of FIG. 2. In the case of FIG. 3, the host 300 is illustrated as operating three virtual machines 310 including virtual machines 310A, 310B and 310C. However, the ellipses 310D once again represents that the principles described herein are not limited to the number of virtual machines running on the host 300. For instance, there may be many more, or even less, than the illustrated three virtual machines 310 in FIG. 3. During operation, the virtual machines emulate a fully operational computing system including at least an operating system, and perhaps one or more other applications as well.

The host 300 includes a hypervisor 320 that emulates virtual resources for the virtual machines 310 using physical resources 321 that are abstracted from view of the virtual machines 310. The hypervisor 320 also provides proper isolation between the virtual machines 310. Thus, from the perspective of any given virtual machine, the hypervisor 320 provides the illusion that the virtual machine is interfacing with a physical resource, even though the virtual machine only interfaces with the appearance (e.g., a virtual resource) of a physical resource, and not with a physical resource directly. In FIG. 3, the physical resources 321 are abstractly represented as including resources 321A through 321C. While only three physical resources are illustrated, ellipses 321D represent that there may be any number of physical resources 321. Examples of physical resources 321 include processing capacity, memory, disk space, network bandwidth, media drives, and so forth. Similarly, FIG. 3 also includes physical processors 322. While only three processors 322 (322A, 322B, and 322C) are shown, ellipses 322D represent that there may be any number of physical processors 322. Furthermore, physical processors 322 may be of any type or architecture.

Host 300 may also include specific processor modes within processors 322, in which hypervisor 320 and virtual machines 310 can execute. Furthermore, hypervisor 320 may program a given processor 322 to monitor execution of the code of a given virtual machine 310, transparently modify the behavior of the virtual machine while the virtual machine is executing, and return control to the hypervisor when certain conditions occur (e.g., the virtual machine performs a privileged operation) that the architecture/hypervisor have specified as meriting the hypervisor's attention. The hypervisor 320 and a given processor 322 may communicate for such purposes (i.e., transferring control, executing entity-specific modes, and so forth) through the use of a shared physical data structure.

An example of how control is transferred, as well as use of the shared pysical data structure follows. In such an example, the hypervisor 320 may set up the state of this shared physical data structure prior to initiating any execution of virtual machines (or nested hypervisors, as described more fully herein). Setting up the state may include setting up the state of both the hypervisor and virtual machines that are running in the host 300. Setting up the state of the data structure also includes identifying mandatory conditions, under which execution control is to be returned to the hypervisor 320. For example, once executing, if a virtual machine 310 performs an instruction or operation that the hypervisor/architecture has identified as privileged, the processor 322 may transfer control from the virtual machine to the hypervisor (i.e., the hypervisor intercepts the operation and retains control).

The hypervisor 320 may initiate execution of a given virtual machine 310 via an instruction, generally referred to as a virtual machine entry (VM entry), which may be resuming execution of an already launched virtual machine or launching a virtual machine for the first time. Once a VM entry has been initiated, the given processor 322 may perform various actions, including validation of various states, saving hypervisor state to, and loading virtual machine state from, the shared physical data structure. The processor 322 may then transfer control to the virtual machine 310 to execute. The virtual machine 310 may then execute with restricted privileges that have been specified by the hypervisor 320, by a particular architecture, or a combination of the two, as described herein.

Eventually, a condition may occur (e.g., privileged operation performed by the virtual machine) that causes the processor to transfer execution control back to the hypervisor. Such a transfer of control from a virtual machine to the hypervisor may be referred to as a virtual machine exit (VM exit—also referred to hereinafter as simply an “exit”). In response to a VM exit, the processor 322 may perform a variety of operations, including validating states, saving virtual machine state to the shared physical data structure, loading hypervisor state that was previously saved to the shared physical data structure, and filling in various fields of the shared physical data structure to indicate why the VM exit occurred.

The processor may then start executing code of the hypervisor 320 (i.e., transfer control to the hypervisor). The hypervisor can then examine the shared physical data structure to determine the cause of the current VM exit and how to handle the VM exit. Handling the VM exit may include modifying controls in the shared physical data structure, modifying its own (i.e., hypervisor) data, modifying a state of the virtual machine, and updating a state of the processor. Once the hypervisor has finished performing the above described actions, it may perform another VM entry, thus starting at the beginning of the described example again.

FIG. 4 illustrates a similar virtualized environment as described in FIG. 3. However, FIG. 4 also includes child hypervisor 420B nested within parent hypervisor 420A (i.e., nested virtualization), as well as virtual machines 412 that are running within hypervisor 420B. Accordingly, parent hypervisor 420A emulates virtual resources for not only virtual machines 410, but also for child hypervisor 420B. While FIG. 4 illustrates only one level of nested virtualization (i.e., hypervisor 420B nested within the most ancestral parent hypervisor 420A), ellipses 420C represents that there may be any number of levels of hypervisors nested within parent hypervisors (e.g., a hypervisor 420C may also be nested within hypervisor a hypervisor 420D (not shown) nested within hypervisor 420C, and so forth). Hereinafter, the collection of nested hypervisors will be referred to as “hypervisors 420”. Additionally, there may be any number of hypervisors and virtual machines running within any particular level of the nested virtualization environment 400. Thus, while virtual machines 410 are illustrated as only having three virtual machines (410A through 410C), ellipses 410D represents that there may be any number of virtual machines 410.

As illustrated, virtual environment 400 includes only three virtual machines 412 (412A through 412C) running within child hypervisor 420B. However, ellipses 412D represent that there may be any number of virtual machines 412 running within child hypervisor 420B. As also described in FIG. 3, physical resources 421 and physical processors 422 are abstracted from view of, and ultimately used to run, the child hypervisor 420B, the virtual machines 410, and the virtual machines 412.

The hypervisors 420 also provide proper isolation between the virtual machines 410 and the virtual machines 412, as described in FIG. 3. Thus, from the perspective of any given virtual machine, the hypervisor running the virtual machine may provide the illusion that the virtual machine is interfacing with a physical resource, even though the virtual machine only interfaces with the appearance (e.g., a virtual resource) of a physical resource, and not with a physical resource directly. This is true regardless of the level of nested virtualization (e.g., hypervisor 420B may provide this illusion to virtual machines 412). In FIG. 4, the physical resources 421 and physical processors 422 are abstractly represented as including resources 421A through 421C and processors 422A through 422C, respectively. While only three physical resources 421 are shown, ellipses 421D represent that there may be any number of physical resources 421. Similarly, while only three physical processors 422 are shown, ellipses 422D represent that there may be any number of physical processors 422. Examples of physical resources 421 include memory, disk space, network bandwidth, processing capacity, media drives, and so forth.

Similarly, hypervisor 420A may also provide the illusion that hypervisor 420B is interfacing with a physical resource, even though hypervisor 420B may only interface with the appearance of a physical resource rather than interfacing with the physical resource directly. For instance, the shared physical data structure described above may be virtualized by the parent hypervisor 420A for child hypervisor 420B. Furthermore, parent hypervisors at each nested level in such a nested virtualization may provide this illusion. For example, hypervisor 420B may provide this illusion when running a hypervisor 420C nested within hypervisor 420B.

Nested virtualization configurations, such as the one described above in connection with FIG. 4, may offer a variety of novel uses. For example, a developer can put his/her entire development environment within a virtual machine. Thus allowing the developer to deploy and test his/her software in a virtual machine, just as if the developer had a non-virtualized computer system dedicated to software development. Further benefits include that a individual can create a cluster on a laptop and demonstrate live migration of a nested virtual machine between nodes of the cluster, wherein each node is a virtual machine running a hypervisor.

While nested virtualization provides the benefits described and more, there are also many complexities involved with nested virtualization, especially in regards to switching control between processor modes for each entity in a nested virtualization environment. Accordingly, the specific processor modes and control transferring described with respect to FIG. 3 become much more inefficient.

For instance, consider the example of a nested (or child) hypervisor 420B that is executing a given virtual machine 412. Suppose a particular privileged condition occurs that would ordinarily cause a VM exit to the hypervisor 420B if the hypervisor were not nested. Also suppose in this case that the given architecture or parent hypervisor 420A has programmed a particular processor 422 to cause a VM exit under that same condition within the current nested virtualization environment. For example, the VM exit from the nested hypervisor may have occurred because the nested hypervisor attempted to launch a virtual machine (i.e., a privileged operation). Once the VM exit occurs, the parent hypervisor 420A may gain control of execution in order to properly handle the exit.

As part of the parent hypervisor's handling of the exit, the parent hypervisor may determine that an exit under this condition is to be handled by the child hypervisor 420B (i.e., the exit is to be forwarded to the child hypervisor). As described, the parent hypervisor generally virtualizes the shared physical data structure to the child hypervisor. As such, the parent hypervisor fills in various fields of the virtualized data structure, including a number of information fields, virtual machine state fields, child hypervisor state fields, and so forth.

Execution of the virtual machine 412 then begins, but to do so, control is transferred to the child hypervisor 420B, essentially causing a virtual exit. To transfer control to the child hypervisor, child hypervisor code, including a state of the child hypervisor, must be loaded from the virtualized data structure and applied to the shared physical data structure. However, this loading to the shared physical data structure may not be performed until after appropriate validation of the code/state of the child hypervisor 420B within the virtualized data structure has been performed by the parent hypervisor 420A.

At this point, the child hypervisor may begin executing, but once again, the execution may be restricted in terms of what operations/instructions may be performed by the child hypervisor. As part of the execution, the child hypervisor may perform various actions, including multiple accesses to the virtualized data structure, modifications of state, and so forth. The child hypervisor may then eventually execute an instruction to again launch a virtual machine (i.e., could be launched for the first time or simply resuming an already launched virtual machine). However, because such an instruction is privileged, executing the instruction to launch a virtual machine will cause an exit to occur. Accordingly, the processor 422 may then transfer control to the parent hypervisor 420A, wherein the parent hypervisor can then emulate the instruction to launch the virtual machine. Emulating the instruction may comprise performing all the actions of such a virtual entry, including saving a state of the parent hypervisor, validating a state of the child hypervisor and/or virtual machine 412, and any other internal processing that may be required to emulate the launch based on particular architecture semantics.

As described above, each virtual exit/virtual entry pair may require at least 2 physical exits and 2 physical entries an initial physical exit that is forwarded to the child hypervisor, and then another physical exit when the virtual entry instruction occurs, which is then converted to a physical entry into the execution of the virtual machine. All of the above occurring after appropriate processing by the parent hypervisor. Accordingly, the inefficiencies of a virtual exit/entry may be twice that of a physical exit/entry, and that does not include any other work performed by the parent hypervisor. The inefficiency with regard to CPU cycles of physical entries/physical exits may vary based on the particular processor, but is likely to be significant, regardless.

Furthermore, in some architectures, the shared physical data structure described with respect to FIG. 3 and the associated virtualized data structure described herein, have a format that is opaque to any nested hypervisors and virtual machines. Accordingly, accessing fields of the virtualized data structure by a nested hypervisor or a virtual machine requires special instructions or accessing special registers rather than directly interacting with the shared physical data structure using ordinary memory operations.

For architectures that utilize this opaque data structure format, each access by the parent hypervisor itself may then cause an additional physical exit/entry pair. The additional physical exit/entry pair being caused because the child hypervisor is not privileged enough to execute the accesses, thus causing the parent hypervisor to emulate the accesses (i.e., instead of only privileged operations causing a virtual exit to the most ancestral parent hypervisor 420A, each time a child hypervisor or virtual machine attempts to interact with the virtualized data structure may cause a virtual exit to occur). Accordingly, running a nested hypervisor may lead to not only twice the number of physical exits/entries, but potentially significantly more on architectures because of opaque data structures requiring special instructions.

To improve the efficiency of accesses to fields within the virtualized data structure on processor architectures that use the opaque format, a shared virtual data structure with a documented data structure format may be provided to any nested hypervisors/virtual machines. Accordingly, the child hypervisor may be notified not only of the existence and location in memory of the shared virtual data structure, but also how to use the shared virtual data structure. For example, the child hypervisor may be notified of characteristics of fields that are included within the shared virtual data structure, such as the types of fields, the number of fields, and/or the sizes of fields included within the data structure.

Similarly, the child hypervisor may be notified how to interact with particular fields included within the shared virtual data structure. For example, the child hypervisor may be notified how to read from, or write to, particular fields within the shared virtual data structure. In some embodiments, the child hypervisor may be able to read from, and write to, the shared virtual data structure using ordinary memory operations.

The shared virtual data structure and associated documented data structure format provided may have the exact same format as the shared physical data structure/opaque data structure for any given architecture. Accordingly, while the physical data structure/opaque data structure format may vary for each different architecture, the same fields (in regards to characteristics of the fields number of fields, types of fields, sizes of fields, and so forth) may be provided within the shared virtual data structure that the shared physical data structure/opaque data structure format possess.

Furthermore, the same semantics used in the shared physical data structure/opaque data structure may also be used in the shared virtual data structure, regardless of the architecture. Thus, the type, location, size, and so forth of the fields within the shared virtual data structure may be documented for the nested hypervisors/virtual machines, making it possible for any nested hypervisors/virtual machines to directly access and manipulate the fields of the shared virtual data structure using standard memory accessing instructions. Accordingly, unnecessary exits are avoided because the child hypervisor is no longer required to use special instructions and/or special registers to access/fill in the data structure (i.e., VM exits will not occur each time a child hypervisor or virtual machine access the shared virtual data structure, as they would without the shared virtual data structure). Thus, at least partially because the shared virtual data structure may have essentially the same format and semantics as the shared physical data structure/opaque data structure, the control flow/program logic of virtual environment 400 may be only minimally changed while significantly improving efficiency.

Once notified of how to interact with the shared virtual data structure, the child hypervisor may begin to do so by performing operations with respect to the data structure. For example, the child hypervisor may read from the data structure, write to the data structure, modify data already within the data structure, add data to the data structure, perform a launch of a virtual machine within the child hypervisor, and so forth. At some point, the child hypervisor may finish performing operations, or more likely, the child hypervisor may perform a privileged operation (e.g., performing an operation to launch a hypervisor or virtual machine) that is intercepted by the parent hypervisor.

However, before finishing operations or performing a privileged operation, the child hypervisor may indicate the memory location of the shared virtual data structure to the parent hypervisor. Additionally, when the child hypervisor indicates the memory location of the shared virtual data structure to the parent hypervisor, the child hypervisor may also indicate to the parent hypervisor that the child hypervisor is enlightened and/or currently performing an enlightened operation. By indicating such enlightenment to the parent hypervisor, the parent hypervisor may then be able to focus (i.e., validate, copy, and so forth) only on data that has been changed/modified/added by the child hypervisor with respect to the shared virtual data structure, as described more fully below.

In some embodiments, the child hypervisor may perform these indications by making a hypercall to the parent hypervisor, indicating both the memory address of the shared virtual data structure and that an enlightened virtual entry is being performed. In other embodiments, the child hypervisor may write the location of the shared virtual data structure to a shared page of both the child hypervisor and the parent hypervisor, as well as a sentinel (i.e., boolean value) that indicates that an enlightened virtual entry is being performed. The child hypervisor may then execute an instruction to initiate a virtual entry (e.g., launching a virtual machine within the child hypervisor). The parent hypervisor may intercept this operation as usual and examine the shared page. When the parent hypervisor identifies the sentinel value, the parent hypervisor knows that an enlightened entry is being performed, with the location of the shared virtual data structure specified in the shared page.

The parent hypervisor may then read from the shared virtual data structure and validate data within the shared virtual data structure. Generally, validation would need to be performed for all data in the shared virtual data structure each time a virtual entry has been attempted by a child hypervisor to ensure that the child hypervisor has not performed any operations/invoked any instructions that break rules set forth by either the given architecture or the parent hypervisor. However, because the child hypervisor has provided the parent hypervisor with an indication of enlightenment, the parent hypervisor may look for an enlightened field that is included within the shared virtual data structure. Such a field may allow the child hypervisor to indicate to the parent hypervisor which specific fields have modified or additional data.

In response, the parent hypervisor may focus on reading only the fields that the child hypervisor has indicated have been changed (or data that has not been changed, but that depends on data that has been changed), thus reducing the cycles spent reading data. Accordingly, validation before each virtual entry can be limited specifically to data that has changed since the last time the data was validated. As such, the very first time the parent hypervisor validates data from the shared virtual data structure, the parent hypervisor validates all of the data within the shared virtual data structure, whether or not the child hypervisor is enlightened. Thus, without enlightenments, the parent hypervisor will validate all of the data within the shared virtual data structure each time a virtual entry is to occur, regardless of how much data has actually changed.

Once all of the data has been validated, the parent hypervisor may copy all of the validated data to the shared physical data structure for use by the physical processors 422. Once again, enlightenments may allow the parent hypervisor to copy only the data from the shared virtual data structure that has changed since the last time the parent hypervisor copied data to the shared physical data structure. However, once again, the first time the parent hypervisor accesses the shared virtual data structure, the parent hypervisor copies all of the validated data within the shared virtual data structure to shared physical data structure. Accordingly, without enlightenments, the parent hypervisor has to copy all of the validated data within the shared virtual data structure to the shared physical data structure each time, regardless of how much data has actually changed. Finally, once the changed data within the shared virtual data structure has been validated and copied, the parent hypervisor may perform any applicable operations (e.g., a virtual entry such as launching a virtual machine within the child hypervisor).

In other embodiments, another enlightenment may reduce the inefficiency of a virtual exit. Such an enlightenment may provide a field in the shared virtual data structure that indicates that a host state (i.e., a state of a parent hypervisor in relation to a child hypervisor or a state of a hypervisor in relation to a virtual machine) specified in the shared virtual data structure conforms to enlightened semantics. In some processor architectures, the shared virtual data structure may indicate a processor state that is to be re-established on a virtual exit (i.e., the state at which the hypervisor would start execution when processing an exit).

Emulating these semantics may require the hypervisor to apply the host state as part of the virtual exit. This may include both validating the host state, either during virtual entry, or at virtual exit time, and applying that state at virtual exit time. Some portions of the host state may include a great deal of complexity and time to validate and apply. The enlightenment may allow the child hypervisor to indicate that for those specific complex fields (which may be documented as part of the enlightenment), the state immediately prior to virtual entry is the same as the state to be reestablish on virtual exit. Accordingly, using these additional enlightenments, the parent hypervisor may skip the validation of those fields, instead caching them at an enlightened virtual entry time. Then on a virtual exit, the parent hypervisor may restore that previously cached state. Thus, greatly reducing the set of the host state to be reestablished.

FIG. 5 illustrates a flow chart of an example method 500 for improving efficiency associated with operating nested hypervisors (i.e., a child hypervisor operating at a higher nested level and a parent hypervisor operating at a lower nested level, such that the child hypervisor operates as a virtual machine hosted by the parent hypervisor). The improved efficiency may be enabled via the use of the shared virtual data structure that both the parent hypervisor and the child hypervisor can edit, as described above. Editing of the shared virtual data structure may not, in and of itself, change the physical data structure that a most ancestral hypervisor uses as a mechanism to control a physical environment of the computer system. Method 500 will be described with respect to the components of FIG. 4. Additionally, the method will be described in relation to a specific example. In the example, suppose parent hypervisor 420A has launched a child hypervisor 420B.

Method 500 includes executing the child hypervisor 420B (Act 510). Execution of the child hypervisor 420B may include notifying the child hypervisor of the shared virtual data structure, and how to use the shared virtual data structure (Act 520). For example, the child hypervisor may be notified of characteristics of fields that are included within the shared virtual data structure. Characteristics of the fields that are included within the data structure may include the types of fields included within the data structure, the sizes of fields within the data structure, the number of fields within the data structure, how to read from fields within the data structure, how to write to fields within the data structure, and so forth.

Execution of the child hypervisor may also include performing one or more operations at the child hypervisor, wherein at least one of the one or more operations includes a privileged operation (Act 530). For instance, the child hypervisor may perform an operation to launch a virtual machine within the child hypervisor. Because the operation performed is privileged, the method includes the parent hypervisor intercepting the at least one privileged operation while control remains with the child hypervisor (Act 540).

In response to intercepting the at least one privileged operation, control may be transferred to the parent hypervisor, wherein transferring control to the parent hypervisor includes executing the parent hypervisor (Act 550). Execution of the parent hypervisor then includes validating at least one of the one or more operations (Act 560). For example, any changes made to the shared virtual data structure by the child hypervisor are validated by parent hypervisor before further processing can be performed in order to ensure that the child hypervisor is not trying to perform operations on the physical processors 422 that the architecture or parent hypervisor have restricted.

As a particular example, if one of the changes to the shared virtual data structure includes the child hypervisor attempting to launch a virtual machine within the child hypervisor, the parent hypervisor must ensure that launching the virtual machine is not a restricted operation before proceeding to launch the virtual machine (i.e., validation). Once validation is complete, the parent hypervisor may copy all of the validated data to the shared physical data structure in order for the physical processor 422 to do some additional processing. Finally, once the parent hypervisor has validated/copied the operations, the parent hypervisor may cause the at least one privileged operation to occur via use of content of the shared virtual data structure (Act 570). Thus, continuing the previous example, once validation has occurred, the parent hypervisor may launch the virtual machine within the child hypervisor.

In this way, a shared virtual data structure can be used to greatly reduce the inefficiencies and complexities associated with using an opaque data structure in a nested virtualization environment. More specifically, a large portion of virtual exits may be avoided by allowing nested entities to access the shared virtual data structure using ordinary memory access operations rather than accessing the opaque data structure using special instructions and/or special registers. Furthermore, enlightenments may be used to by a parent hypervisor to more efficiently validate changed data and copy the changed/validated data from the shared virtual data structure to a shared physical data structure.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more processors;
one or more computer readable storage media having stored thereon computer-executable instructions that are executable by the one or more processors to cause the computer system to improve efficiency associated with operating nested hypervisors that include a child hypervisor operating at a higher nested level and a parent hypervisor operating at a lower nested level such that the child hypervisor operates as a virtual machine hosted by the parent hypervisor, the improved efficiency enabled via the use of a shared virtual data structure that both the parent hypervisor and the child hypervisor can edit such that editing of the shared virtual data structure does not, in and of itself, change a physical data structure that a most ancestral hypervisor uses as a mechanism to control a physical environment of the computer system, the computer-executable instructions including instructions that are executable to cause the computer system to perform at least the following:
execute the child hypervisor, execution of the child hypervisor including at least the following:
notifying the child hypervisor of the shared virtual data structure, and how to use the shared virtual data structure; and
performing one or more operations at the child hypervisor, at least one of the one or more operations including a privileged operation;
intercept the at least one privileged operation while control remains with the child hypervisor;
in response to intercepting the at least one privileged operation, transfer control to the parent hypervisor, the transferring of control to the parent hypervisor including executing the parent hypervisor, wherein execution of the parent hypervisor includes at least the following:
validating the at least one privileged operation; and
causing the at least one privileged operation to occur via use of content of the shared virtual data structure.

2. The computer system of claim 1, wherein notification of the shared virtual data structure comprises notifying the child hypervisor of characteristics of fields included in the shared virtual data structure.

3. The computer system of claim 2, wherein the characteristics of the fields included in the shared virtual data structure include at least one of:
types of the fields included in the shared virtual data structure; and
sizes of the fields included in the shared virtual data structure.

4. The computer system of claim 1, wherein execution of the child hypervisor also includes indicating at least one modification to the shared virtual data structure made by the child hypervisor.

5. The computer system of claim 1, wherein execution of the child hypervisor also includes indicating a location in memory of the shared virtual data structure.

6. The computer system of claim 5, wherein the indication of the location in memory of the shared virtual data structure is performed via a shared page.

7. The computer system of claim 1, wherein execution of the parent hypervisor also includes copying the at least one privileged operation from the shared virtual data structure to a physical data structure after the at least one privileged operation has been validated.

8. A method, implemented at a computer system that includes one or more processors, for improving efficiency associated with operating nested hypervisors that include a child hypervisor operating at a higher nested level and a parent hypervisor operating at a lower nested level such that the child hypervisor operates as a virtual machine hosted by the parent hypervisor, the improved efficiency enabled via the use of a shared virtual data structure that both the parent hypervisor and the child hypervisor can edit such that editing of the shared virtual data structure does not, in and of itself, change a physical data structure that a most ancestral hypervisor uses as a mechanism to control a physical environment of the computer system, comprising:
executing the child hypervisor, execution of the child hypervisor including at least the following:
notifying the child hypervisor of the shared virtual data structure, and how to use the shared virtual data structure; and
performing one or more operations at the child hypervisor, at least one of the one or more operations including a privileged operation;
intercepting the at least one privileged operation while control remains with the child hypervisor;
in response to intercepting the at least one privileged operation, transferring control to the parent hypervisor, the transferring of control to the parent hypervisor including executing the parent hypervisor, wherein execution of the parent hypervisor includes at least the following:
validating at least one of the one or more operations; and
causing the at least one privileged operation to occur via use of content of the shared virtual data structure.

9. The method of claim 8, wherein the parent hypervisor is the most ancestral hypervisor.

10. The method of claim 8, further comprising indicating, during execution of the child hypervisor, at least one modification to the shared virtual data structure made by the child hypervisor.

11. The method of claim 8, further comprising indicating, during execution of the child hypervisor, a location in memory of the shared data structure.

12. The method of claim 11, wherein the indication of the location in memory of the shared data structure is performed by a hypercall.

13. The method of claim 8, further comprising copying, during execution of the parent hypervisor, the at least one validated operation from the shared virtual data structure to a physical data structure.

14. The method of claim 8, wherein the one or more operations includes at least one of:
writing to the shared virtual data structure; and
reading from the shared virtual data structure.

15. A method, implemented at a computer system that includes one or more processors, for improving efficiency associated with operating nested hypervisors that include a child hypervisor operating at a higher nested level and a parent hypervisor operating at a lower nested level such that the child hypervisor operates as a virtual machine hosted by the parent hypervisor, the improved efficiency enabled via the use of a shared virtual data structure that both the parent hypervisor and the child hypervisor can edit such that editing of the shared virtual data structure does not, in and of itself, change a physical data structure that a most ancestral hypervisor uses as a mechanism to control a physical environment of the computer system, comprising:
executing the child hypervisor, execution of the child hypervisor including at least the following:
notifying the child hypervisor of the shared virtual data structure, and how to use the shared virtual data structure;
making one or more modifications to the shared virtual data structure, at least one of the one or more modifications comprising performing a privileged operation; and
indicating the one or more modifications to the shared virtual data structure;
intercepting the at least one privileged operation while control remains with the child hypervisor;
in response to intercepting the at least one privileged operation, transferring control to the parent hypervisor, the transferring of control to the parent hypervisor including executing the parent hypervisor, wherein execution of the parent hypervisor includes at least the following:
validating the one or modifications to the shared virtual data structure based on the indication; and
causing the at least one privileged operation to occur via use of content of the shared virtual data structure.

16. The method of claim 15, wherein how to use the shared virtual data structure includes instructions to use ordinary memory operations

17. The method of claim 15, further comprising indicating, during execution of the child hypervisor, enlightenment of the child hypervisor.

18. The method of claim 17, wherein the indication of the enlightenment is performed via a shared page.

19. The method of claim 15, further comprising copying, during execution of the parent hypervisor, the one or more modifications from the shared virtual data structure to a physical data structure after the one or more modifications have been validated.

20. The method of claim 15, wherein the at least one privileged operation comprises an instruction to launch a virtual machine within the child hypervisor.
